(19) United States
(12) Patent Application Publication
(10) Pub. No.: US 2022/0336900 A1
(43) Pub. Date: Oct. 20, 2022

(54) LIGHTWEIGHT BATTERY HOUSING ASSEMBLY

(71) Applicants: Miguel MERINO, Sterling Heights, MI (US); Venugopal GARIMELLA, Troy, MI (US); Cangji SHI, Troy, MI (US); Scott Douglas SHIELDS, White Lake, MI (US); John Anthony INGRAM, Richmond Hill (CA); Ranjit PACHHA, Brampton (CA); Axel LACHENMAIER, Rudersberg (DE)

(72) Inventors: Miguel MERINO, Sterling Heights, MI (US); Venugopal GARIMELLA, Troy, MI (US); Cangji SHI, Troy, MI (US); Scott Douglas SHIELDS, White Lake, MI (US); John Anthony INGRAM, Richmond Hill (CA); Ranjit PACHHA, Brampton (CA); Axel LACHENMAIER, Rudersberg (DE)

(21) Appl. No.: 17/640,893

(22) PCT Filed: Sep. 4, 2020
(86) PCT No.: PCT/US2020/049353

§ 371 Date: Mar. 7, 2022

Related U.S. Application Data
(60) Provisional application No. 62/896,852, filed on Sep. 6, 2019.

(51) Int. Cl. H01M 50/209; H01M 10/613; H01M 10/625; H01M 10/6557; H01M 50/229; H01M 50/224; H01M 50/249

(52) U.S. Cl. CPC H01M 50/209; H01M 10/613; H01M 10/625; H01M 10/6557; H01M 50/229; H01M 50/224; H01M 50/249; H01M 2220/20

(57) ABSTRACT

A lightweight battery housing for an automobile and method of assembling same. The lightweight battery housing comprises an upper cover, a tub, and a protection frame whereon the upper cover and lower tub sit. The upper cover and tub may comprise at least one of a steel material, an aluminum material, and/or a fiber-reinforced composite. The protection frame comprises at least one of steel material and aluminum material. The tub includes pockets for holding battery modules and seals against the cover to provide a leak-resistant battery holder. Fasteners connect the tub, cover, and protection frame and a seal is placed between the tub and the cover. The cover and other components of the battery housing may be integrated directly into a body-in-white of the vehicle.

### CROSS-REFERENCE TO RELATED APPLICATION

This PCT International Patent application claims the benefit of and priority to U.S. Provisional Patent Application Ser. No. 62/896,852 filed on Sep. 6, 2019, and titled “Lightweight Battery Housing Assembly,” the entire disclosure of which is hereby incorporated by reference.

### BACKGROUND OF THE INVENTION

### 1. Field of the Invention

The present invention relates a battery housing and a method of assembling same. More particularly, the present invention relates to a lightweight battery housing for an automobile and method of assembling same.

### 2. Related Art

This section provides background information related to the present disclosure which is not necessarily prior art.

Automobiles are the subject of a continuing effort to reduce weight and increase fuel efficiency without detracting from performance. This desire to increase fuel efficiency is both economically and environmentally motivated and has advanced internal components in automobiles as evidenced by developments in batteries, particularly in electrified automobiles. Unlike traditional automobiles that operate entirely with fossil fuels, electrified automobiles include a range of technologies that rely on electric energy. Some electrified automobiles still rely predominantly on fossil fuels and use electricity as a supportive energy to improve fuel efficiency, while other electrified automobiles rely predominantly or entirely on electricity for operation of the automobile. Even though electric energy is a more economical and environmentally friendly over relying completely on fossil fuels, batteries are heavy, expensive, and relatively fragile compared to neighboring mechanical components. As such, the packaging of batteries, particularly within an electrified vehicle, requires a number of design considerations including weight distribution, temperature regulation, and serviceability. In terms of serviceability, there is a growing need, particularly with electrified automobiles, for the batteries to be stowed in such a manner to be charged and maintained without removal.

To meet the above minimum requirements, batteries have traditionally been packaged in protective housings. These traditional housings have utilized metal intensive (aluminum and/or steel) designs to meet strength and fire resistance requirements at costs to increased weight, leak performance, and vulnerability to corrosion. In addition to the shortcomings during operation, these traditional housings also require a significant amount of energy, time, and capital to construct. For example, many traditional housings use aluminum extrusions welded to aluminum plates and meeting dimensional tolerances are difficult, oftentimes requiring further machining steps. Once constructed, traditional housings are difficult to integrate into body-in-white.

Accordingly, there is a continuing desire to further develop and refine housing construction and operation such that they are not subjected to traditional drawbacks.

### SUMMARY OF THE INVENTION

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims. This section provides a general summary of the disclosure and is not to be interpreted as a complete and comprehensive listing of all of the objects, aspects, features and advantages associated with the present disclosure.

According to one aspect of the disclosure, a lightweight battery housing for an automobile is provided. The lightweight battery housing comprises a battery holder including a battery holder rim extending around a peripheral battery holder edge. The battery holder includes an inner surface for placement of the at least one battery module and an exterior surface defining at least one groove. The lightweight battery housing further includes a frame having an outer frame and at least one beam extending across the outer frame. The battery holder is located within the outer frame and the battery holder rim sits on and is connected to a top surface of the outer frame with the at least one beam sitting within the at least one groove.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is a perspective view of a battery housing assembly for an automobile according to a first embodiment;

FIG. 2 is a perspective view of the battery housing assembly in a disassembled condition;

FIG. 3 is an enlarged view of the battery housing assembly including molded battery attachments;

FIG. 4 is a perspective view of the battery housing assembly including a single seal surface;

FIG. 5 is a cross-sectional view of the battery housing assembly;

FIG. 6 is a perspective view of the battery housing assembly in accordance with a second embodiment;

FIG. 7 is a perspective view of the second embodiment of the battery housing assembly in a disassembled condition;

FIG. 8 is a cross-sectional view of the battery housing connected to a body-in-white;

FIG. 9 is a perspective view of the battery housing assembly in a disassembled condition in accordance with a third embodiment;

FIG. 10A is a cross-sectional view of the battery housing assembly presented in FIG. 9 in accordance with a first arrangement;

FIG. 10B is a cross-sectional view of the battery housing assembly presented in FIG. 9 in accordance with a second arrangement;

FIG. 10C a perspective view of the battery housing assembly presented in FIG. 9 in accordance with a third arrangement;

FIG. 10D is a disassembled perspective view of FIG. 10C;

FIG. 11 is a perspective view of the third embodiment of the battery housing assembly, wherein a tub is being connected to a frame;

FIG. 12 is a perspective disassembled view of a battery housing assembly including a first embodiment of an external thermal management system;

FIG. 13 is a perspective view of the external thermal management system including a conduit connected to the battery housing assembly for distributing cooled or heated liquid medium;

FIG. 14 is a cross-sectional view of the conduit connected to the battery housing assembly;

FIG. 15 is a top perspective view of the battery housing assembly with the external thermal management system;

FIG. 16 is a bottom perspective view of the battery housing assembly with the external thermal management system;

FIG. 17 is an enlarged top perspective view of the tub illustrating a connection port for connecting the conduit;

FIG. 18 is a perspective disassembled view of the battery housing assembly including a second embodiment of the external thermal management system;

FIG. 19 is a disassembled perspective disassembled view of the battery housing assembly including a third embodiment of the external thermal management system;

FIG. 20 is a cross-sectional view of the third embodiment of the external thermal management system;

FIG. 21 is a cross-sectional view of a compensation assembly between the frame and an upper cover;

FIG. 22 is a cross-sectional view of a thermal management layer of the battery housing assembly including laminated, thermal control layers; and

FIG. 23 is a method flow chart illustrating a method of constructing the battery housing assembly.

### DESCRIPTION OF THE ENABLING EMBODIMENT

Example embodiments will now be described more fully with reference to the accompanying drawings. In general, the subject embodiments are directed to a battery housing assembly for an automobile and method of assembling same. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, wherein like numerals indicate corresponding parts throughout the views, the battery housing assembly for an automobile and method of assembling same are intended for providing a lightweight and relatively simple to construct design for protecting, distributing weight, and allowing easy serviceability.

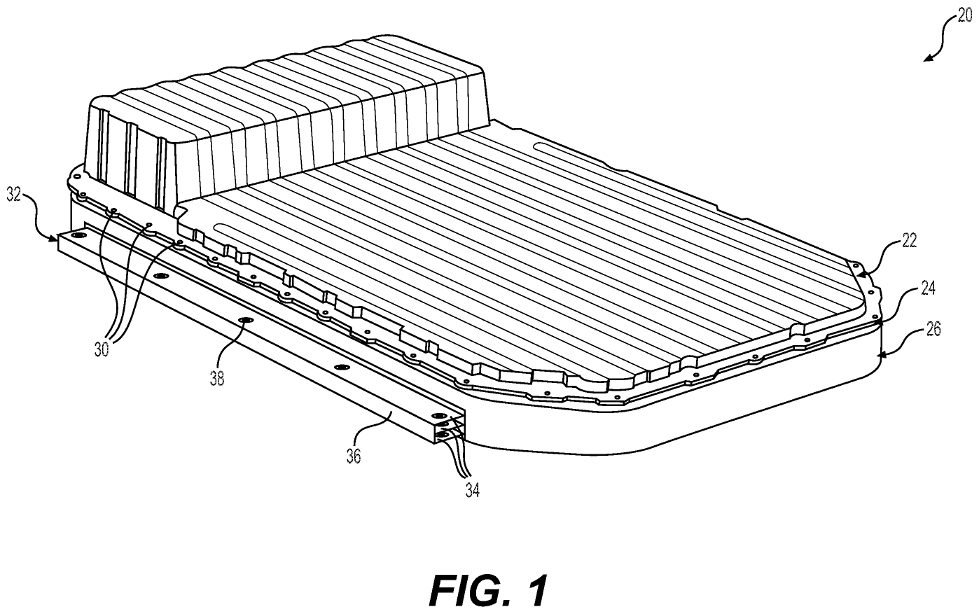

Referring initially to FIG. 1 through FIG. 4, a first embodiment of the battery housing assembly 20 for an automobile is presented. In one example, the battery housing assembly 20 may be used in an electrified automobile. The battery housing assembly 20 includes an upper cover 22, a tub 24, and a protection frame 26. A protection plate 27 formed of steel, aluminum, or sheet molding compound (SMC) such as Glass Fiber Reinforced Plastic or Carbon Fiber Reinforced Plastic is located beneath and connected to the frame 26. The protection frame 26 provides a rigid and/or semi-rigid base on which the upper cover 22 and tub 24 can be stacked. The tub 24 is formed to hold at least one but preferably a plurality of battery modules 28 and the cover 22 sits on top of the tub 24 and is connected via a plurality of connectors 30, such as threaded fasteners. The cover 22 and tub 24 thus encase the battery modules 28 and are connected to the protection frame 26, which is configured to optimize the distribution of weight of the battery modules 28. The protection frame 26 further includes at least one bracket 32 that can be connected to an automobile frame. The bracket 32 includes a plurality of stacked metallic plates 34 connected via an intermediate plate 36 and a series of fastener tubes 38 extending through and connected to each of the stacked metal plates 34 for connection to the automobile frame via fasteners.

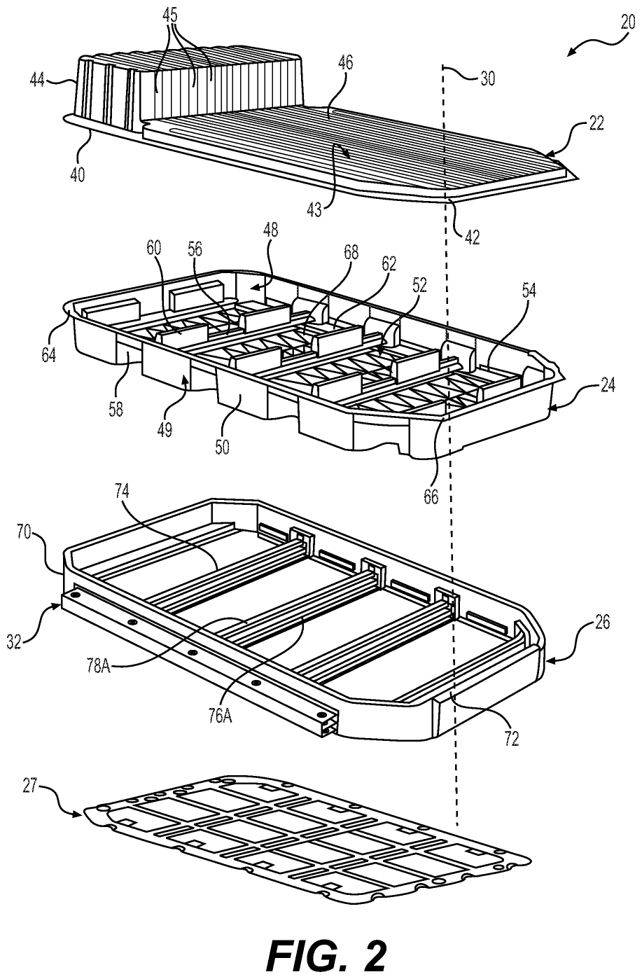

FIG. 2 illustrates the battery housing assembly 20 in a disassembled condition. The cover 22 includes a cover rim 40 around a peripheral edge that is generally aligned along a flat plane. Cooperating cover apertures 42 are disposed around the cover rim 40 for connection to the tub 24 via the afore described connectors 30. The cover 22 further includes an exterior surface 43 defining a series of channels 45 for guiding water and other debris away from the battery housing assembly 20. The cover 22 further includes a hood portion 44 and a flat portion 46, wherein the hood portion 44 extends outwardly from the exterior surface 43 such that when the cover 22 is placed over the tub 24, the hood portion 44 can fit overtop stacked battery modules 28 and/or taller battery modules 28 than those aligned under the flat portion 46.

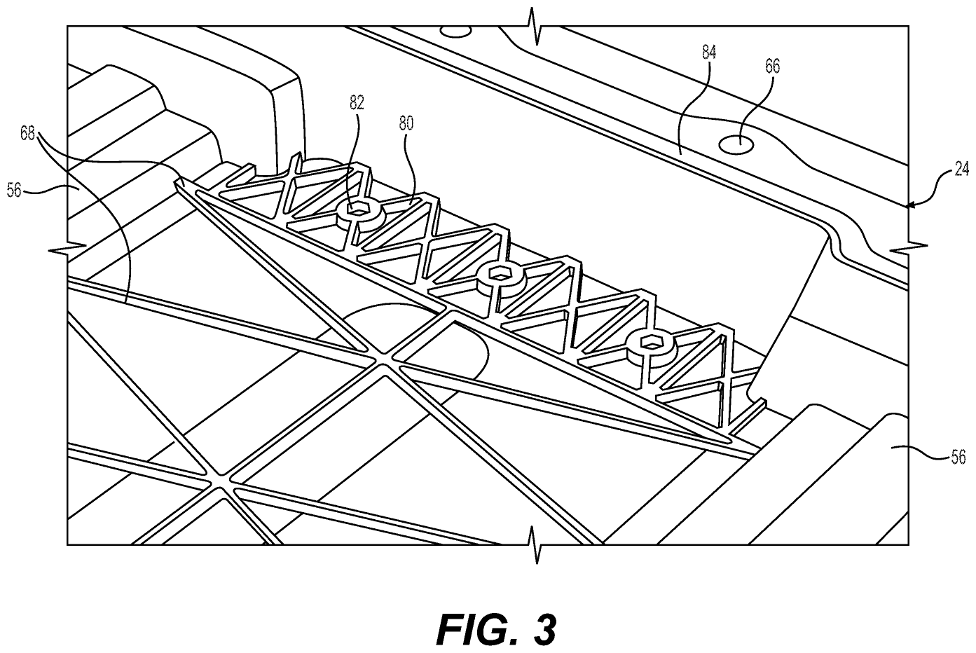

The tub 24 includes an interior surface 48 and an exterior surface 49 both defining a sidewall 50 extending around a base 52. The interior surface 48 defines a plurality of pockets 54 each for nesting one or more battery modules 28. The pockets 54 are defined by ribs 56 that extend outwardly from the interior surface 48 of the base 52 and the sidewall 50. On the exterior surface 49 the ribs 56 are hollow so as to define grooves 58. A series of spacer members 60 are connected to a top surface of the ribs 56 for connection to the battery modules 28 and for absorbing side-to-side movement during operation of the automobile. Structural members 62 are located between ribs 56 adjacent to the sidewall 50 such that battery modules 28 may be placed at least partially thereon. The spacer members 60 and structural members 62 may be formed integrally with the tub 24 or may be attached as separate pieces. In addition, the spacer members 60 and structural members 62 may be formed of a material that is stronger than that of the remainder of the tub 24. The tub 24 further includes a tub rim 64 having a shape corresponding to the cover rim 40 for being overlaid during assembly. Similarly, the tub rim 64 may also include cooperating tub apertures 66 for alignment with cooperating cover apertures 42. In addition to the ribs 56, the base 52, and the sidewall 50 include a matrix of structural webbing 68 (see also FIG. 3).

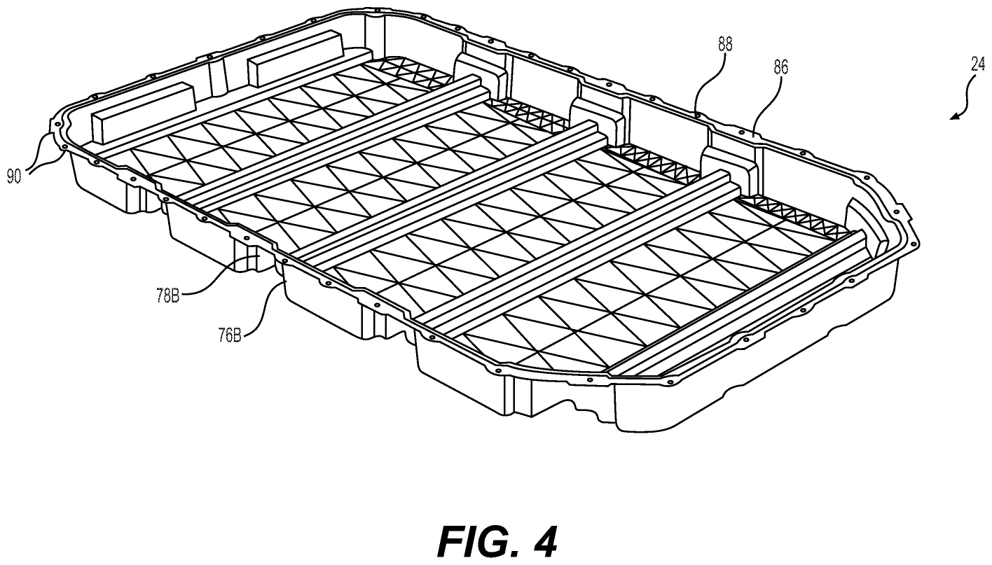

The protection frame 26 includes an outer frame 70 that includes a corresponding shape to the cover rim 40 and tub rim 64. The outer frame 70 includes a top surface with cooperating frame apertures 72 that align with the cooperating cover apertures 42 and the cooperating tub apertures 66 such that connectors 30 extend through each of the cooperating apertures 42, 66, and 72. The protection frame 26 further includes a plurality of beams 74 extending across the outer frame 70. When the tub 24 is placed on the protection frame 26, the beams 74 fit within the grooves 58 such that the pockets 54 are located between and hang from the beams 74. The spacer members 60 and structural members 62 may be connected through the tub 24 and directly to the protection frame 26. The beams 74 and grooves 58 may both also have a stepped shape with a wide base section 76A, 76B and a narrow top section 78A, 78B (see also FIG. 4). As such, the spacer members 60 may further clip the top sections 78A, 78B together.

FIG. 3 illustrates an enlarged view of the tub 24 and more particularly the structural webbing 68 on the interior surface 48. A concentrated webbing 80 is located between each of the ribs 56 for supporting the structural members 62. The concentrated webbings 80 may also include openings 82 each defined by a raised border for receiving fasteners/pins (not shown) from the structural members 62. The tub rim 64 includes a seal run channel 84 that extends between the sidewalls 50 and cooperating tub apertures 66 for placement of a seal 86 (FIG. 4) that compresses against the cover 22 during the tightening of connectors 30. The seal 86 thus prevents liquid and other debris from entering the assembled battery housing assembly 20. FIG. 4 illustrates the tub 24 having a seal 86 extending along the tub rim 64. The seal 86 in FIG. 4 may be located in the channel 84 or the channel 84 may not be present. The seal 86 is illustrated as covering the entire tub rim 64 and presents a series of seal apertures 88 aligned with the other cooperating apertures 42, 66, 72. The tub rim 64 and seal 86 may include tabs 90 of wider portions for increased overlap with cover rim 40 which may also include tabs. Seal apertures may be located in the tabs 90.

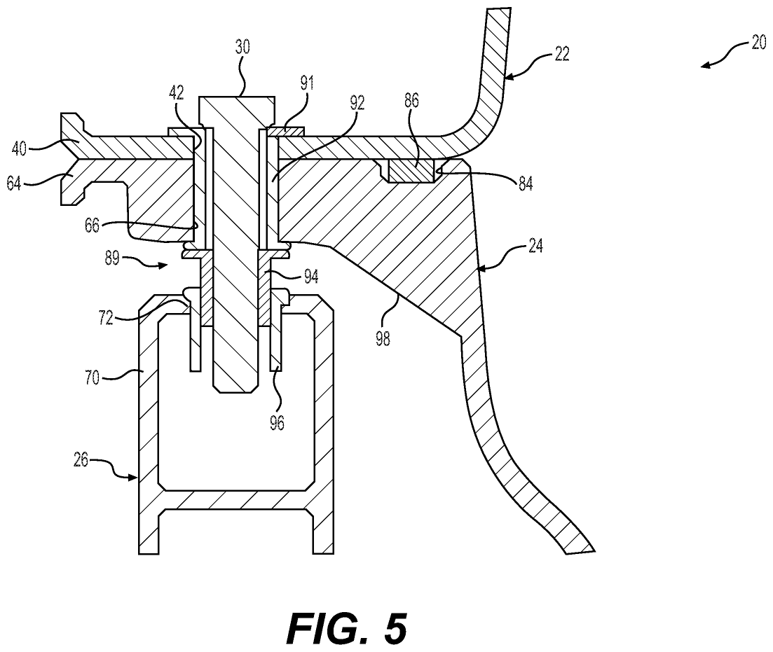

FIG. 5 is a partial cross-sectional view of the battery housing assembly 20 that illustrates the connection between the cover 22, the tub 24, and the protection frame 26. The seal 86 is shown to be located predominantly or entirely within the channel 84. A tolerance compensation assembly 89 connects the cover 22, the tub 24, and the protection frame 26. The tolerance compensation assembly 89 includes a washer 91 and may also include a grommet 92 that sits in the cooperating aperture 66 of the tub 24 and passes through one of the corresponding cooperating apertures 42 of the cover 22 and abuts the washer 91. The connector 30 extends through the grommet 92 and threadingly engages a first bushing 94 which is connected to a second bushing 96. The second bushing 96 is connected to cooperating aperture 72 in the protection frame 26. The tub 24 is shown to include fillet material 98 that adds structure thickness and strength adjacent to the tub rim 64. The tolerance compensation assembly 89 maintains dimensional stability without requiring any machining steps on or around the seal.

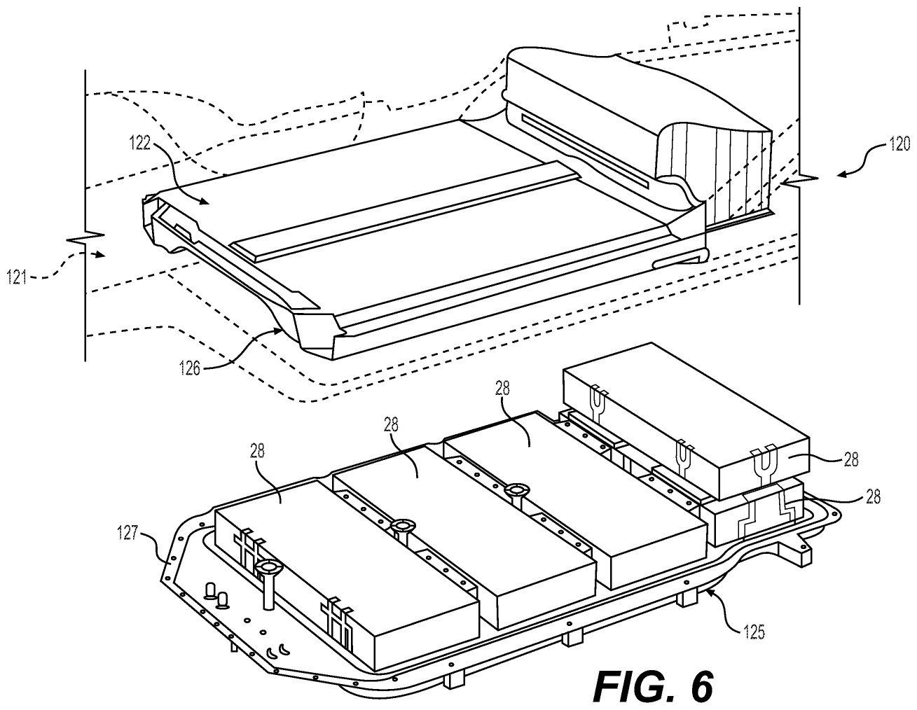

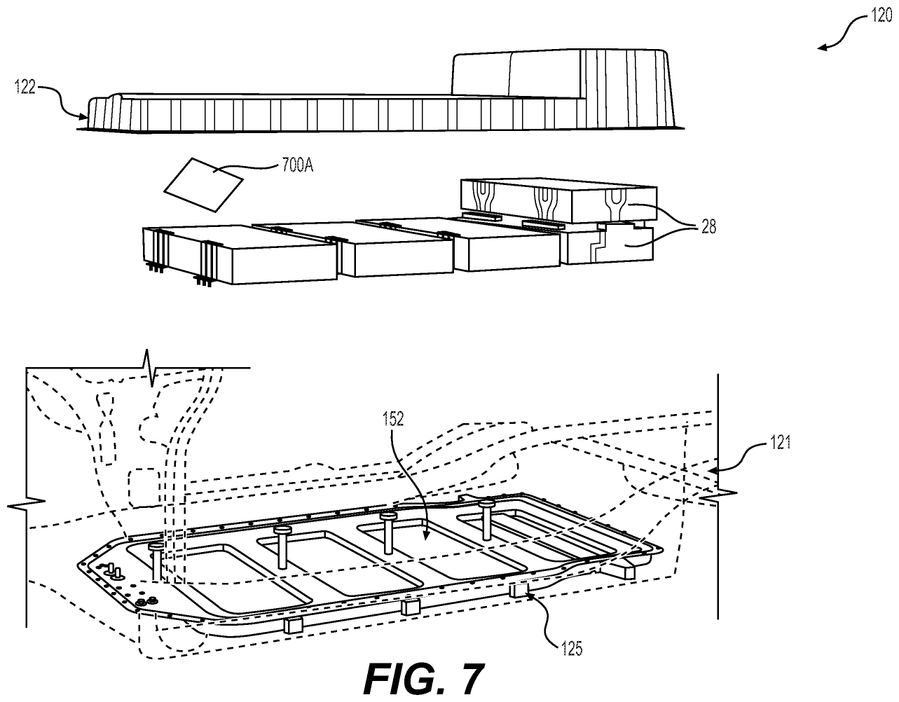

FIG. 6 and FIG. 7 illustrate the battery housing assembly 120 in accordance with a second embodiment. The battery housing assembly 120 includes a cover 122 and a frame 126 that is an integrated structure with the body-in-white 121. The battery housing assembly 120 also includes a tray 125 that may be assembled into the body-in-white 121. The integrated cover 122 and frame 126 may eliminate duplicate components and provides for a lightweight alternative to traditional battery housings. A lower tray 125 provides a base on which the battery modules 28 sit. They tray 125 may then slide into a space defined by the cover 122 and frame 126. A seal 127 is located along a rim of the tray 125 and a rim of the cover 122 that may be connected similarly to the previous embodiments. Other features, materials, and construction methods of the battery housing assembly 120 may be similar to those of the first embodiment. FIG. 7 is a perspective view of the battery housing assembly 120 in a disassembled condition. The cover 122 and frame 126 may be initially integrated into the body-in-white 121 from inside the cabin. The cover 122 could be a single or multi-piece component and the battery modules 28 may be installed onto the tray 125 as separate components or as a stack of pre-connected battery modules 28 before the tray 125 is connected and sealed to the frame 126.

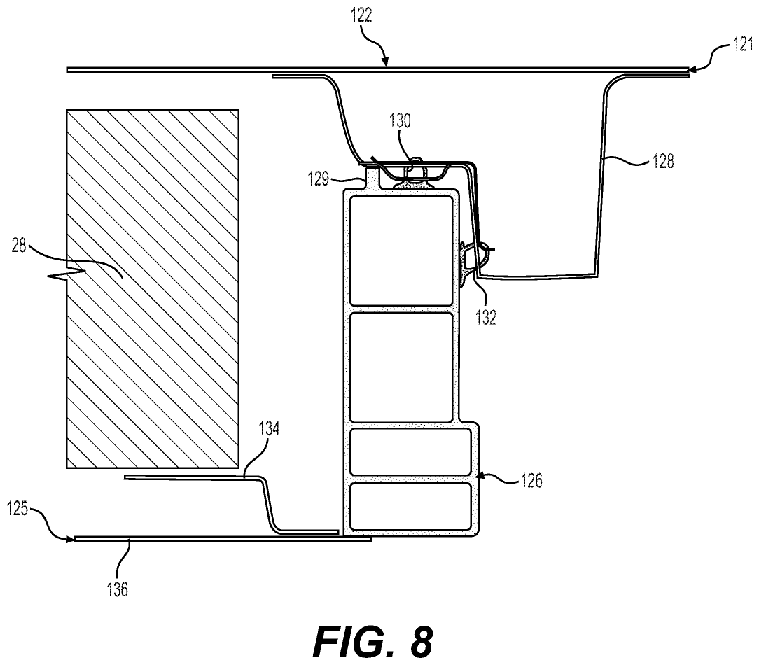

FIG. 8 is a is a cross-sectional view of the battery housing 120 connected to the body-in-white 121. As illustrated, the cover 122 may be integrated with the body-in-white 121 and may further serve as a body-in-white floor 121 for dual functionality. The cover 122 integrates with a body-in-white rails or rockers 128. The frame 126 then connects to the rockers 128 via fasteners 129, welding, or other methodologies. A first seal 130 is located between a top surface of the frame 126 and the rocker 128 and a second seal 132 is located between a side surface of the frame 126 and the rocker 128. The rocker 128 includes a stepped surface 132 for locating the frame 126 such that the first seal 130 is located between surfaces that are perpendicular to the surfaces located on either side of the second seal 132. Both seals 130, 132 are compressed during connection between the frame 126 and the rocker 128. The frame 126 and rocker 128 may both define rectilinear or otherwise closed shapes such that the seals 130, 132 encircle the entirety of the battery modules 28. When the tray 125 is connected or previously integrated with a bottom surface of the frame 126. As illustrated, the tray 125 may include projections 134 to hold the battery modules 28 off of a floor 710 of the tray 125.

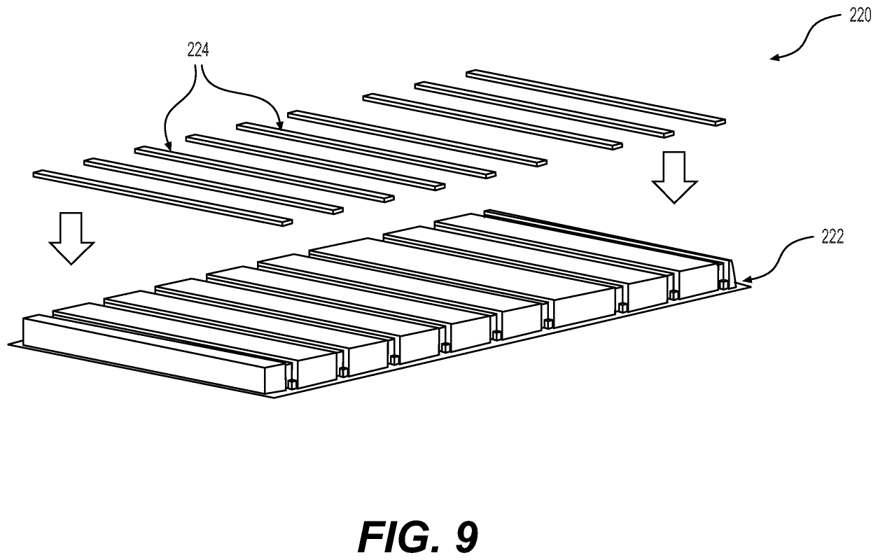

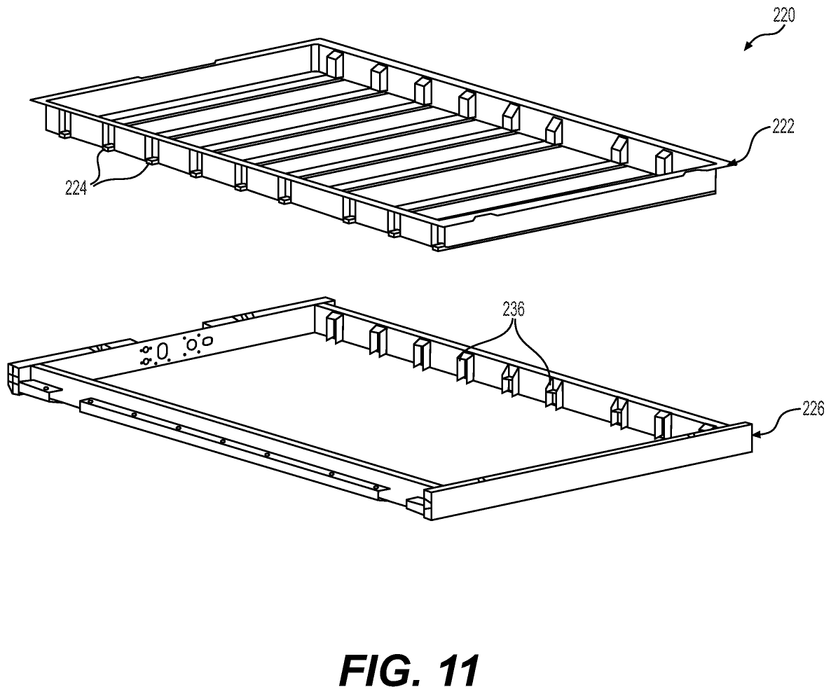

FIG. 9 through FIG. 11 illustrate the battery housing assembly 120 in accordance with a third embodiment. FIG. 9 is a perspective view of the battery housing assembly 220 in a disassembled condition. The battery housing assembly 220 includes a tub 222 an a series of beams 224 similar to beams 74. The beams 224 may be formed of from aluminum extrusion or steel roll forming. The tub 222 may be formed of SMC such as Glass Fiber Reinforced Plastic or Carbon Fiber Reinforced Plastic. The tub 222 may be formed via a molding process, wherein the beams 224 are molded into grooves 223 during the molding process. The beams 224 may be formed of aluminum or steel. The beams 224 are spaced such that they create a load path from vehicle side impact loads to protect the battery modules 28 during vehicle impact event and will attach directly to frame 226 (see FIG. 11).

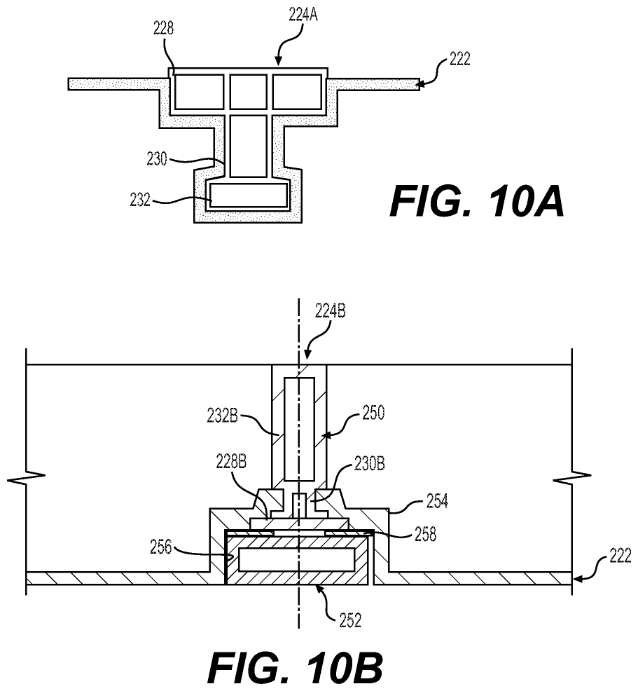

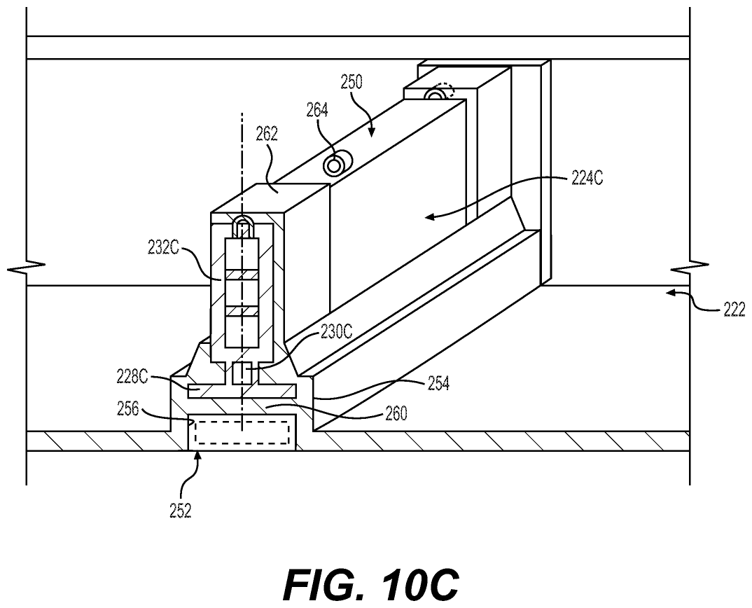

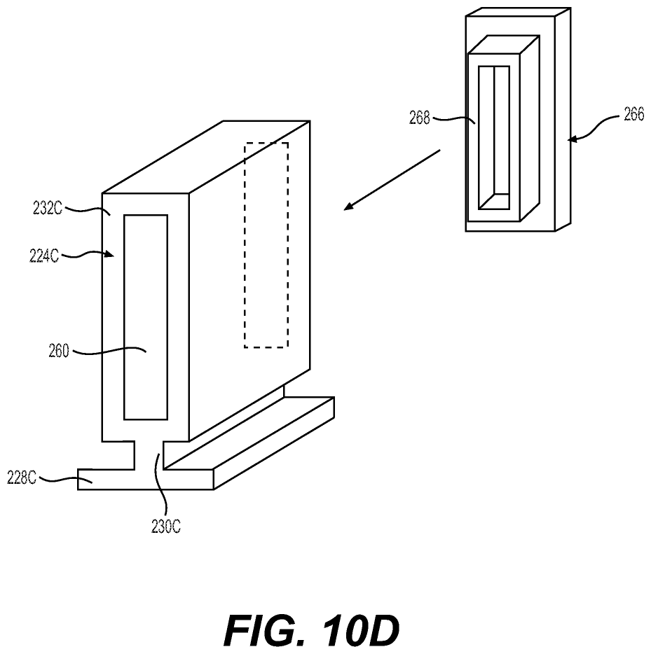

FIG. 10A is a cross-sectional view of the beams 224A molded into the tub 222 in accordance with a first arrangement of the over-molded beams 224. The beams 224A include a base section 228A that narrows into a body section 230A and expands again into a top section 232A. The molded tub 222 is molded over at least part of the base section 228A, the body section 230A, and the top section 232A.

FIG. 10B is a cross-sectional view of the beams 224B molded into the tub 222 in accordance with a second arrangement of the over-molded beams 224. The beams 224B each include a first beam part 250 and a second beam part 252. The first beam part 250 is molded into the tub 222 to project from an interior surface 223. More particularly, the first beam part 250 includes a base section 228B that narrows into a body section 230B and expands again into a top section 232B. The molded tub 222 includes a stepped rib 254 that is molded over at least part of the base section 228B, the body section 230B, and the top section 232B. The stepped rib 254 defines a groove 256 on the opposite side for placement of the second beam part 252. The second beam part 252 includes a rectangular cross-section and connects to the base section 228 via connects, adhesive, welding, and/or other methodologies. In the illustrated example, an adhesive 258 connects to the base section 228 to the second beam part 252.

FIG. 10C is a cross-sectional view of the beams 224C molded into the tub 222 in accordance with a third arrangement of the over-molded beams 224. The beams 224C each include a first beam part 250 and a second beam part 252 similar to the second arrangement in FIG. 10B. The first beam part 250 is molded into the tub 222 to project from an interior surface 223 and includes the same base section 228C, the body section 230C, and the top section 232C. However, the connection between the first beam part 250 and the tub 222 is modified. More particularly, the tub 222 includes a rib 254 that defines a groove 256 similar to the second arrangement in FIG. 10B and further includes a divider section 260 that is over molded around a bottom surface of the base section 228C and spaces it from the second beam part 252. The tub 222 further includes one or more over-molded bands 262 that extend from the rib 252 and wrap around the first beam part 250. As such, cross-sectional locations at the over-molded bands 262 completely encase the first beam part 250. The second beam part 252 fits within groove 256 and is spaced from the first beam part 250 by the divider section 260. The second beam part 252 may be connected to the divider section 260 via an adhesive and may further be connected to the first beam part 250 via fasteners 264 that extend through the first beam part, the divider section 260, and the second beam part 252. Fasteners 264 may also extend through the over-molded bands 262. FIG. 10D is a disassembled view of the third arrangement presented in FIG. 10C. The tub 222 may further include molded brackets 266 that are arranged for connection to opposite sides of the first beam part 250. The brackets 266 may be integral or later added to sidewalls of tub 222. The brackets 266 include projections 268 for mating with an aperture 270 in the body section 230C.

FIG. 11 illustrates the tub 222, the beams 224, and the frame 226 from FIG. 9 in a disassembled condition. The beams 224 are over molded into the tub 222 such that they project outwardly passed a side wall 234 of the tub 222 so that it can be connected to the frame 226. The frame 226 includes a plurality of clips 236 for connection to opposite sides of each beam 224. The frame 226 and clips 236 may be formed of a metal material such as aluminum or steel.

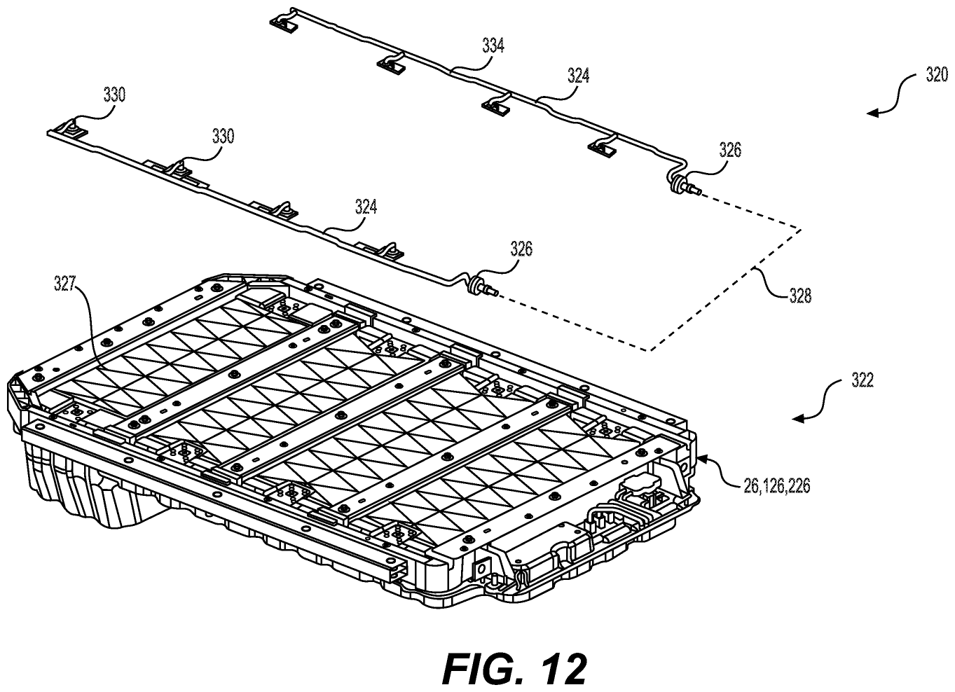

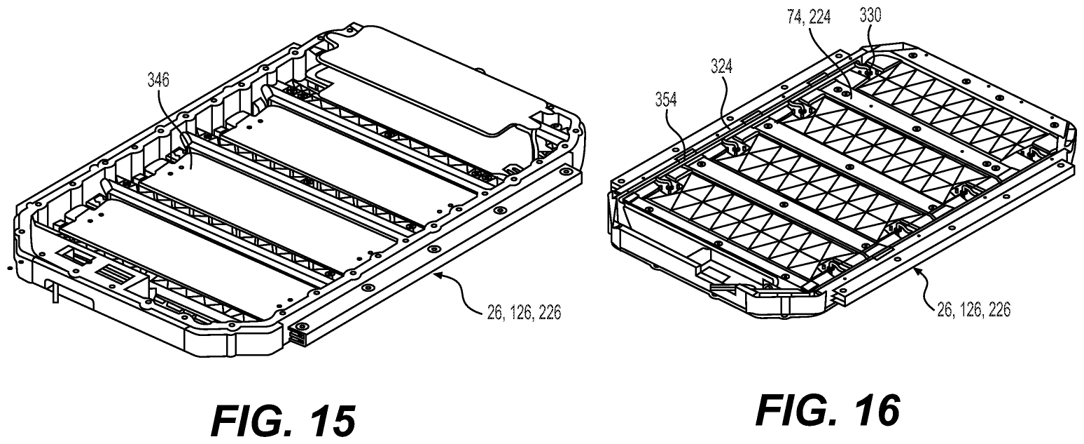

FIG. 12 is a perspective view of an external thermal management system 320 that may be used in conjunction with any of the embodiments of the battery housing assembly described herein. The external thermal management system 320 includes a manifold 322 located on a bottom surface of a tub 24, 224 or tray 125 (generically referred to as “battery holder”) that transfers a temperature controlled medium around and adjacent battery modules 28. More particularly, the manifold 322 includes a pair of conduits 324 that extend along opposites sides of the frame 26, 126, 226. Each conduit 324 includes and input/output 326 that connects to a coolant system 328 of an associated automobile. Each conduit 324 further includes a series of ports 330 that are interconnected or paired with ports of the opposite conduit 324. Extending between each of the paired ports 330 are coolant lines, such as one or more coolant plates 332 (see FIGS. 14 and 15). The conduits 324 may further include a series of connection clips 334 for connection to support beams 74, 224 and/or a protection plate 327.

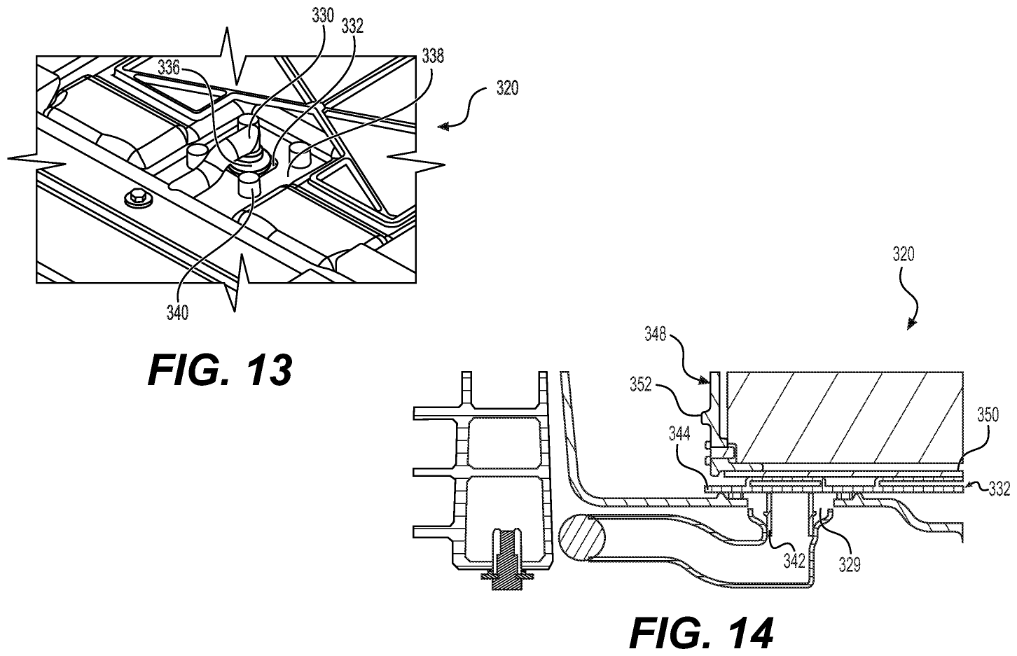

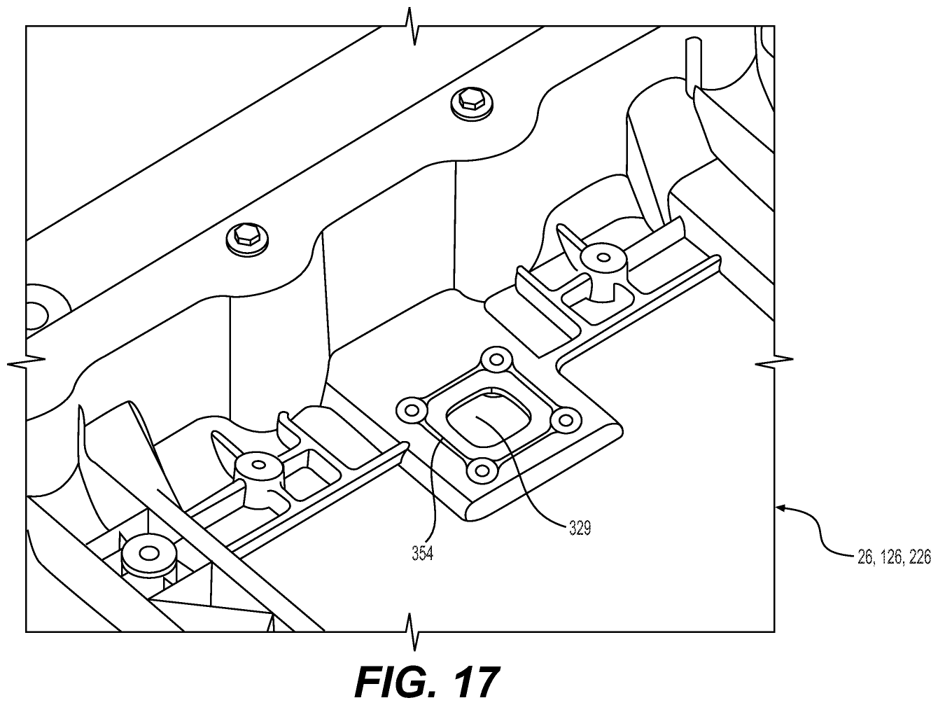

FIG. 13 is an enlarged view of one of the ports 330 connected to the coolant plate 332 through an fluid aperture 329 in the battery holder. Each port 330 includes a conical section 336 that seals against an undersurface of the battery holder around the fluid aperture 329. The undersurface of the battery holder includes a flattened portion 338 without webbing for facilitating the sealed connection. The flattened portion 338 includes a series of fastener housings 340 for insertion of fasteners from an upper surface of the battery holder. FIG. 14 illustrates a cross-section of the port 330 connected to the battery holder. The conduit 324 is recessed into the respective frame 26, 126, 226 to avoid damage. The coolant plate 332 includes a cylindrical projection 342 that is inserted into the associated port 330. The coolant plate 332 further includes a base plate 344 and a series of enclosed channels 346 at least partially defined by the base plate 344. The channels 346 may define flat rectangular-shaped walls that are strong enough to support the weight of the battery modules 28. The battery module 28 may include an exterior shell 348 that includes a base portion 350 comprising thermally conductive material and side portions 352 of SMC material. FIG. 15 is a top side view of the external thermal management system 320 located in a battery holder and frame 26, 126, 226. The external thermal management system 320 includes two vertically stacked channels 346 for vertically stacked battery modules 28. Beams 74, 224 may be located between horizontally adjacent channels 346. FIG. 16 is a bottom perspective view of the external thermal management system 320 on a battery holder wherein beams 74, 224 include a series of grooves 354 for locating the conduits 324 safely within frame 26, 126, 226. FIG. 17 is an enlarged view of a top surface of the battery holder including fastener apertures that extend into the fastener housing 340 and the fluid aperture 329. A fluid seal 354 extends around the fluid aperture 329 and seals against the coolant plate 332 during connection.

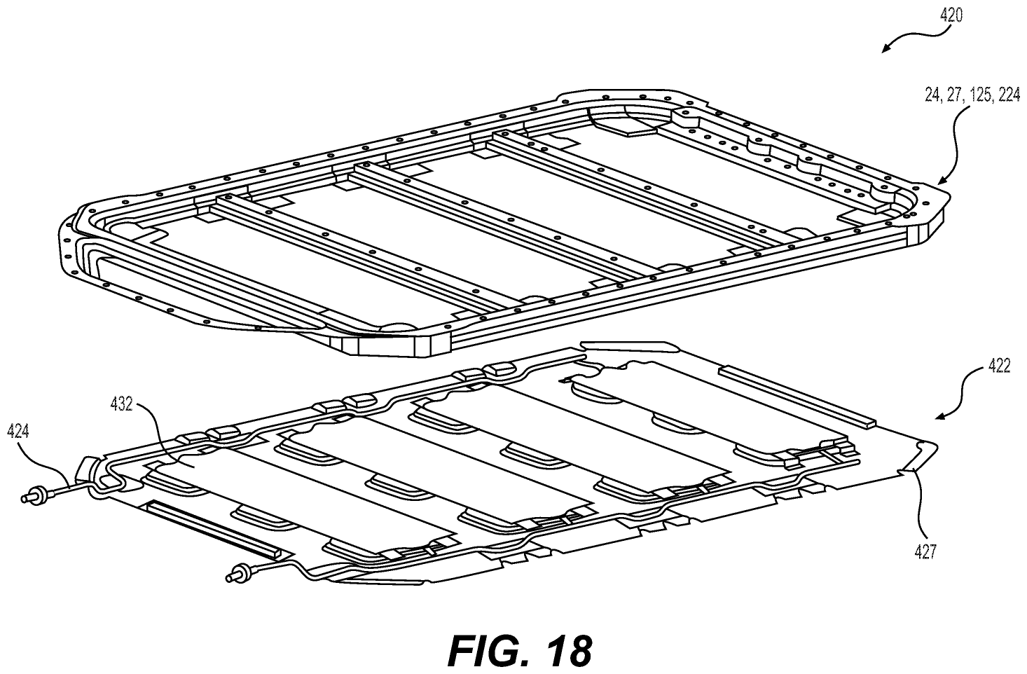

FIG. 18 is a perspective view of an external thermal management system 420 in accordance with a second embodiment that may be used in conjunction with any of the battery housing assembly embodiments described herein. The external thermal management system 420 many include any of the afore described components of the first embodiment of the external thermal management system 320, however, the external thermal management system 420 is integrated with the battery holder. More particularly, the external thermal management system 420 includes a manifold 422 that includes conduits 424, similar to conduits 324, that connect to coolant plates 432. The manifold 422 is integrated with a protection plate 427, which locates the various components of the manifold 422. During assembly the base plate 434 the manifold 422 is located on the base plate 434 such that is modular and can be connected directly to an underside of a battery holder and or additional protection plate 27. The connection may be temporary with fasteners or permanent with welding.

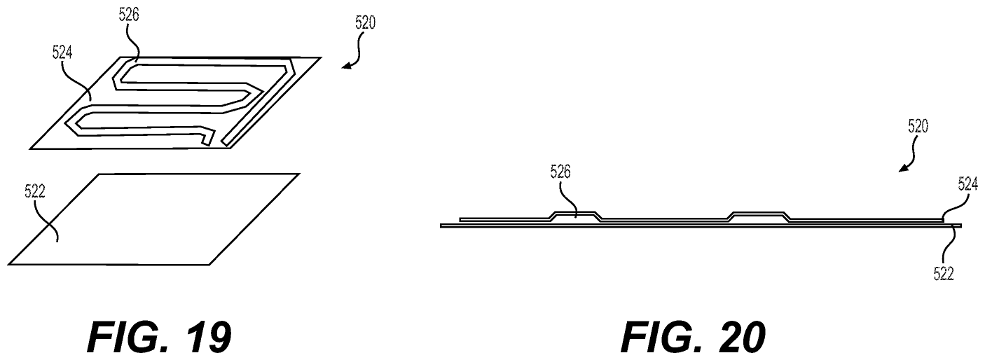

FIG. 19 is a perspective view of an external thermal management system 520 in accordance with a third embodiment that may be used in conjunction with any of the other embodiments described herein. The external thermal management system 520 many include any of the afore described components of the first and second embodiments of the external thermal management system 320, 420. The external thermal management system 520 includes a bottom plate 522 (similar to the protection plate 27) and a top plate 524 with at least one coolant channel 526 defined by one of the bottom plate 522 and a top plate 524. The bottom plate 522 and a top plate 524 are then connected to one another (see FIG. 20) and connected to an exterior surface of the battery holder, for example, via braze welding. The coolant channel 526 includes an input 526 and an output 528 and may define a serpentine pattern. As best illustrated in FIG. 20 the cross-sectional shape of the coolant channel 526 may include flat top surfaces for placement and support of the battery modules 28. Plates 522, 524 may be installed permanently or temporarily on the protection plate 27 or other features of the battery holder.

It should be appreciated that in each embodiment of the external thermal management system, either cool or heated coolant may be provided as is provided in traditional automotive coolant systems 328. External portions improve serviceability and replacement.

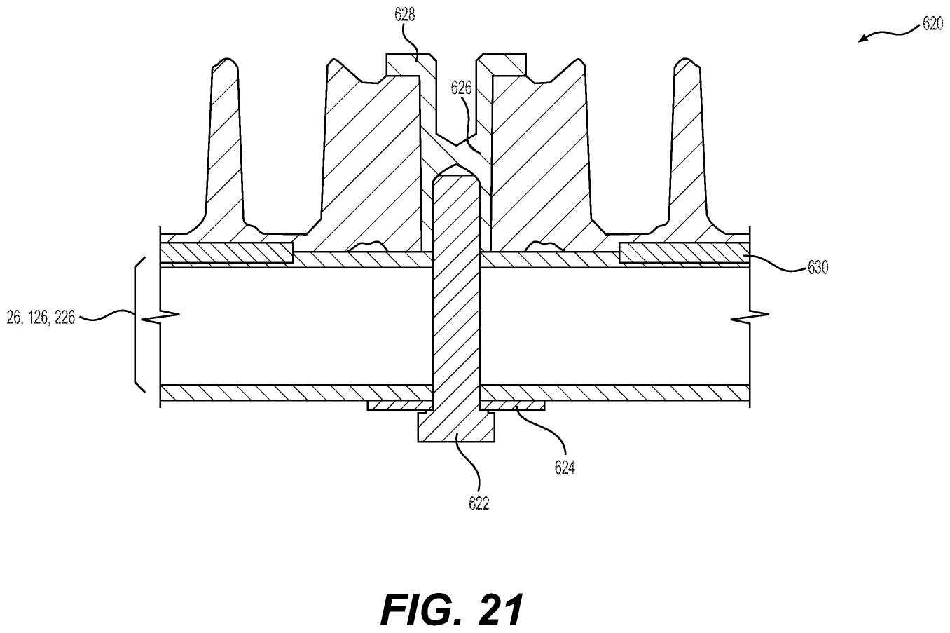

FIG. 21 is a cross-sectional view of a double sided insert assembly 620 which may be used to connect the frame 26, 126, 226 to the battery holder and provides a connection from the exterior of the frame 26, 126, 226 through to the interior of the frame 26, 126, 226 and into the battery holder to minimize loads thereto. The frame 26, 126, 226 may include or further be connected to one of the previously described protection plates 27, 327, 427. The double sided insert assembly 620 includes a fastener 622 extending through a bottom surface of the frame 26, 126, 226 and includes a washer 624 also located on the bottom surface of the frame 26, 126, 226. The fastener extends through the frame 26, 126, 226 and past a top surface thereof and enters the battery holder wherein it connects to a clip bolt 626 that includes a section for connecting to the fastener 622 and a chamfered section 628 for resting on top of an inner surface which may include internal webbings or ribs of the battery holder. A layer of adhesive 630 is located between the top surface of the frame 26, 126, 226 and a bottom surface of the battery holder. The double sided insert assembly 620 may be used in conjunction with any other embodiments described herein.

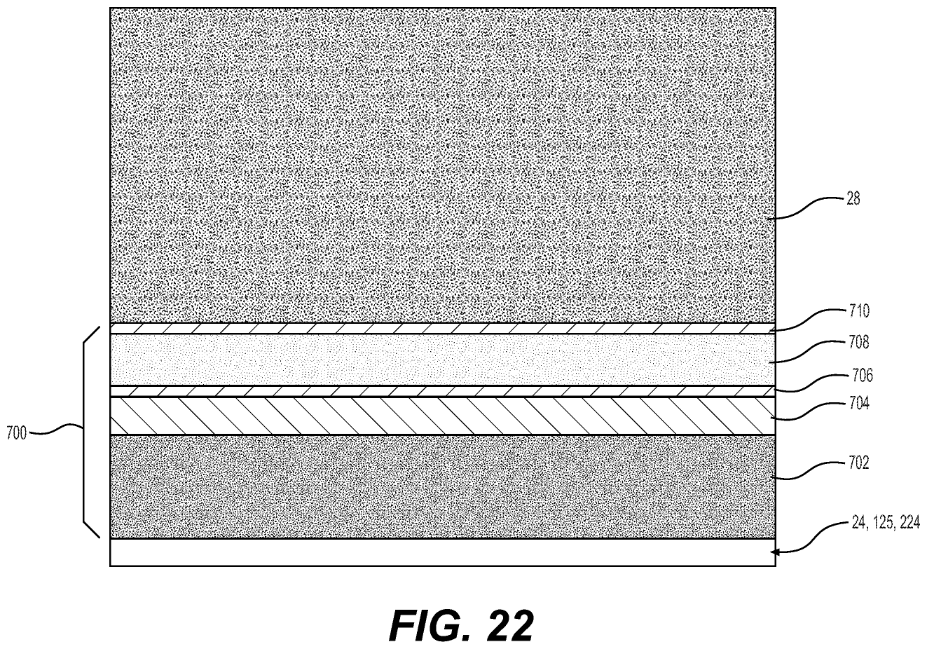

FIG. 22 is a cross-sectional view of a thermal management layer 700, which may include a plurality of sub-layers. The thermal management layer 700 may be present in one or more portions of the various embodiments of the battery housing assembly 20, 120, 220, including any associated components, for example, the cover 22, 122, the tub 24, the tray 125, the pockets 54, the sidewall 50, the base 52, the ribs 56, the spacer members 60, structural members 62. The thermal management layer 700 includes, from an outside surface to an inside surface, an impact resistant sub-layer 702, a cooling and/or heating (i.e., thermal control) sub-layer 704, a first conductive material sub-layer 706, a thermal storage sub-layer 708, and a second thermal conductive sub-layer 710. Individually and/or in combination, the plurality of sub-layers insulate from ambient during cold or hot weather temperatures (e.g., impact resistant sub-layer 702), remove heat from battery modules during normal and abuse operating conditions (e.g., cooling and/or heating sub-layer 704 and thermal storage sub-layer 708), store heat to be used to keep batteries warm at cold weather temperatures (e.g., thermal storage sub-layer 708), and protect battery modules 28 by absorbing energy in case of an impact (e.g., impact resistant sub-layer 702). In accordance with one embodiment, the thermal storage sub-layer 708 may be formed of aluminum foam with integrated phase change material, the thermal control sub-layer 704 may comprise of the previously described coolant conduits 346, 432, and/or 526, the thermal conductive sub-layers 706, 710 may be formed of a metal material such as aluminum, steel, copper, and the impact resistant sub-layer 702 may be formed of polyurethane.

In addition, the thermal management layer 700 may be formed as a non-integral thermal management module 700A (FIG. 7) that may be located on any of the afore described locations, for example, between the battery modules 28 and the battery holder via fasteners, adhesive and/or welding. The thermal management module 700A may also completely cover the battery modules 28, may be located only on certain sides of the battery modules 28, or may cover part of an interior surface of the battery holder and/or cover 22, 122. The thermal management layer 700 and/or the thermal management module 700A may include all or only individual layers. It should be appreciated that the thermal management layer 700 could be incorporated into any of the afore described embodiments. The thermal management layer 700 and/or the thermal management module 700A may be attached directly to one or both of the spacer members 60 and the structural members 62.

The battery housing assembly 20, 120, 220 may be constructed from a variety of different materials and methods such that the battery housing assembly 20, 120, 220 is multi-material. For example, the upper cover 22, 122 may be constructed from steel stamping, aluminum stamping, aluminum casting or SMC such as a fiber-reinforced composite (fire resistant) sheet molding compound. The battery holder may also be constructed from steel stamping, aluminum stamping, aluminum casting or SMC such as fiber-reinforced composite (fire resistant) sheet molding compound. The protection frame 26, 126, 226 may be constructed from steel stamping, aluminum stamping, aluminum extrusion or aluminum casting. The battery holder and the cover 22, 122 may be constructed from of any of the aforementioned materials and methods. The battery holder may be single piece (for improved leak resistance) or may incorporate separate spacer members 60 and structural members 62. For example, the battery holder may be constructed out of aluminum (via any of the afore described methods) or fiber-reinforced composite (fire resistant) and the members 60, 62 and protection frame 26, 126, 226 may be constructed out of steel (via any of the afore described methods). It should be appreciated that references to aluminum and steel may also include aluminum alloys and steel alloys.

The battery housing assembly 20, 120, 220 is designed to accommodate and protect the battery modules 28 used in an automobile, for example, an electrified automobile. The battery housing assembly 20, 120, 220 also accommodates the thermal management systems 320, 420, 520 (e.g., cooling plates, pipes, hoses and connectors), electric wires (to connect battery modules 28 and electronic modules), electronic control modules among other devices. The battery housing assembly 20, 120, 220 can thus provide a multi-material solution to optimize mass saving, meet fire resistance standards via incorporation of fiber-reinforced composite material, minimize the machining process, and eliminate welds and create a single seal surface. In addition, the battery housing assembly 20, 120, 220 allows for component consolidation, provides an improved sealing method with sealing surface stiffness, and integrates the various components and parts to eliminate duplicate structure for mass saving.

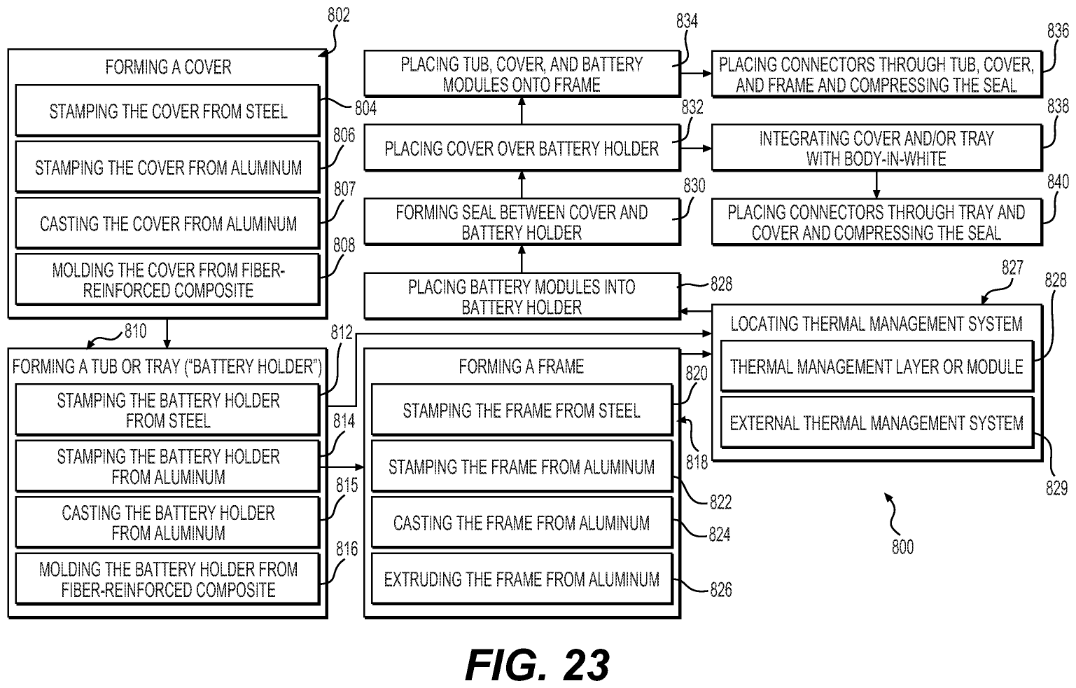

In accordance with yet another aspect of the invention, a method 800 of constructing a battery housing assembly out of multiple materials is illustrated in FIG. 23. The method 800 includes forming a cover 802, which may include stamping 804 the cover from steel, stamping 806 the cover from aluminum, casting 807 the cover from aluminum, or molding 808 the cover from fiber-reinforced composite. The method 800 further includes forming 810 a battery holder, which may include stamping 812 the battery holder from steel, stamping 814 the battery holder from aluminum, casting 815 the battery holder from aluminum, or molding 816 the battery holder from fiber-reinforced composite. Step 816 may include molding the battery holder around an already formed frame from step 818. The method 800 further includes forming 818 a frame, which may include stamping 820 the frame from steel, stamping 822 the frame from aluminum, casting 824 the frame from aluminum, or extruding 826 the frame from aluminum. The method 800 further includes placing 828 battery modules into the battery holder, forming 830 a seal between the battery holder and the cover, and placing 832 the cover over the battery holder. Before (or alternatively after) the step 828, the method may further include placing/locating/connecting 827 a thermal management system. Step 827 may include locating 829 a layer or module between at least one battery module and the battery holder and/or between at least one battery module and the cover. Step 827 may further include incorporating 831 an external thermal management system. In instances of the tub, the method 800 includes placing 834 the tub, cover, and battery modules onto the frame and continues with placing 836 connectors through the tub, the cover, and the frame and compressing the seal. In instances with the tray, step 832 is followed with integrating/connecting 838 the cover and/or the tray with the body-in-white and placing 840 connectors through the tray and cover and compressing the seal. The step 838 may include welding the cover and/or the tray to the body-in-white and/or otherwise connecting it with fasteners, adhesives, or other methodologies.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1-15. (canceled)

16. A lightweight battery housing for an automobile comprising:
a battery holder formed of a sheet moulding compound (SMC) and having a base for placement of at least one battery module;
said battery holder including at least one rib extending upwardly from said base to define at least one groove extending along an exterior surface of said battery holder; and
an outer frame including at least one beam extending in mating relationship through said at least one groove.

17. The lightweight battery housing of claim 16, wherein said battery holder is comprised of glass fiber reinforced plastic or carbon fiber reinforced plastic.

18. The lightweight battery housing of claim 16, wherein said battery holder is tub-shaped and includes a sidewall extending around and upwardly from said base, and said outer frame is disposed in surrounding relationship with said sidewall.

19. The lightweight battery housing of claim 18, further comprising a protection plate extending below said battery housing and interconnected to said outer frame.

20. The lightweight battery housing of claim 16, wherein said at least one beam is molded into said at least one groove during a forming of said battery holder.

21. The lightweight battery housing of claim 16, further comprising:
said at least one rib including a plurality of ribs extending upwardly from said base in spaced relationship with one another to define a plurality of pockets each disposed between adjacent ones of said plurality of ribs;
said at least one groove including a plurality of grooves extending along said exterior surface of said battery holder, with each of one said plurality of grooves defined by adjacent ones of said plurality of ribs;
said at least one beam including a plurality of beams each extending in mating relationship through a respective one of said plurality of grooves;
at least one battery module disposed in each one of said plurality of pockets; and
a spacer member interconnected to each one of said plurality of ribs and said respectively mated one of said plurality of beams for securing said at least one battery module in said respective one of said plurality of pockets and absorbing side-to-side movement of said at least one battery module during use of the lightweight battery housing.

22. The lightweight battery housing of claim 21, wherein said spacer member is comprised of a material being different and stronger than said SMC material of said battery holder.

23. The lightweight battery housing of claim 19, further comprising:
said outer frame presenting a top surface; and
said battery holder including a battery holder rim extending outwardly from said sidewall in resting and overlaying relationship along said top surface of said outer frame.

24. The lightweight battery housing of claim 23, further comprising a cover formed of a sheet molding compound (SMC) and covering said battery holder.

25. The lightweight battery housing of claim 24, further comprising:
said cover including a cover rim disposed in overlaying relationship with said battery holder rim;
said top surface of said outer frame defining at least one frame aperture;
said battery holder rim defining at least one battery holder rim aperture;
said cover rim defining at least one cover aperture;
said at least one frame aperture and said at least one battery holder rim aperture and said at least one cover aperture disposed in aligned relationship with one another; and
a tolerance compensation assembly disposed in and extending through said aligned apertures for interconnecting said cover and said battery holder and said outer frame with one another.

26. The lightweight battery housing of claim 25, further comprising:
said tolerance compensation assembly including a grommet extending through said aligned battery holder rim aperture and cover aperture;
said tolerance compensation assembly including a first grommet connected to a second grommet disposed in said at least one cover aperture; and
said tolerance compensation assembly including a connector extending through said grommet and disposed in threaded engagement with said first bushing.

27. The lightweight battery housing of claim 25, further comprising a seal extending between said battery holder rim and said cover rim.

28. The lightweight battery housing of claim 16, further comprising a clip bolt disposed within and resting along said at least one rib of said battery housing, and a fastener extending upwardly through said at least one beam of said outer frame and interconnected to said clip bolt for securing said at least one beam within said at least one groove.

29. The lightweight battery housing of claim 21, further comprising:
a coolant plate disposed in each of said plurality of pockets in sandwiched relationship between said base of said battery housing and said at least one battery module;
said base of said battery housing defining at least one fluid aperture disposed adjacent said coolant plate; and
a thermal management system including at least one conduit extending along said outer frame and having at least one port passing through said at least one fluid aperture and disposed in fluid communication with said coolant plate for managing a temperature of said at least one battery module.

30. The lightweight battery housing of claim 29, wherein said at least one conduit includes an input/output for connection to a coolant system of the automobile.

31. The lightweight battery housing of claim 29, wherein said coolant plate includes a cylindrical projection extending downwardly from said coolant plate and inserted into said at least one port.

32. A method of manufacturing a lightweight battery housing, comprising:
molding a battery housing from a sheet molding compound (SMC) to present a base and at least one rib extending upwardly from said base to define at least one groove extending along an exterior surface of the formed battery housing;
forming a frame from a steel or aluminum material to define an outer frame and at least one beam extending between opposing sides of the outer frame; and
placing the battery housing within the frame to dispose the at least one beam of the frame in extending relationship along and within the at least one groove of the battery housing.

33. The method of manufacturing the lightweight battery housing of claim 32, further comprising:
molding a cover from a sheet molding compound (SMC); and
placing the cover over the battery housing.

34. The method of manufacturing the lightweight battery housing of claim 33, further comprising:
collectively interconnecting the cover, the battery housing and the frame with a tolerance compensation assembly.

35. The method of manufacturing the lightweight battery housing of claim 32, further comprising:
placing at least one battery module within the battery housing; and
connecting a spacer member collectively to the at least one rib and the at least one beam to secure the at least one battery module within battery housing and absorb side-to-side movement of the at least one battery module during use of the lightweight battery housing.
